(19) United States
(12) Patent Application Publication
(10) Pub. No.: US 2024/0368328 A1
(43) Pub. Date: Nov. 7, 2024

(54) ULTRAVIOLET-CURABLE HEAT-DISSIPATING RESIN COMPOSITION, HEAT-DISSIPATING PRESSURE-SENSITIVE ADHESIVE SHEET, LAYERED PRODUCT, AND METHOD FOR PRODUCING LAYERED PRODUCT

(71) Applicant: SEKISUI CHEMICAL CO., LTD., Osaka (JP)

(72) Inventors: Chiharu OKUHARA, Osaka (JP); Kaito NEMOTO, Shiga (JP); Shinji KAWADA, Osaka (JP); Shuuyji KAGE, Tokyo (JP); Tomoki TODA, Osaka (JP)

(73) Assignee: SEKISUI CHEMICAL CO., LTD., Osaka (JP)

(21) Appl. No.: 18/565,758

(22) PCT Filed: May 30, 2022
(86) PCT No.: PCT/JP2022/021984

§ 371 Date: Nov. 30, 2023

(30) Foreign Application Priority Data
Jun. 2, 2021 (JP) 2021-093191

(51) Int. Cl. C08F 283/00; C08F 2/50; C08K 3/22; C08K 3/28; C09J 4/06

(52) U.S. Cl. CPC C08F 283/008; C08F 2/50; C08K 3/22; C09J 4/06; C08K 2003/2227; C08K 2003/2296; C08K 2003/282; C08K 2201/001

(57) ABSTRACT

The present invention aims to provide a UV-curable heat-dissipating resin composition having excellent printability, excellent heat dissipation properties, and excellent adhesion to various substrates. The present invention also aims to provide a heat-dissipating adhesive sheet containing the UV-curable heat-dissipating resin composition, a laminate, and a method for producing a laminate. Provided is a UV-curable heat-dissipating resin composition containing: (A) a nitrogen-containing monomer; (B) a monofunctional (meth) acrylate monomer; (C) a crosslinking component; (D) a photopolymerization initiator; and (E) a thermally conductive filler having a thermal conductivity of 3 W/m·K or higher, the thermally conductive filler (E) being contained in an amount of 20 to 70% by volume, the nitrogen-containing monomer (A) being contained in an amount of 10 to 35% by weight relative to a whole amount of the composition excluding the thermally conductive filler (E).

### TECHNICAL FIELD

The present invention relates to a UV-curable heat-dissipating resin composition having excellent printability, excellent heat dissipation properties, and excellent adhesion to various substrates. The present invention also relates to a heat-dissipating adhesive sheet containing the UV-curable heat-dissipating resin composition, a laminate, and a method for producing a laminate.

### BACKGROUND ART

Adhesives are used to bond electronic components inside electronic devices such as smartphones and PCs. With a typical method of bonding using an adhesive, first, an adhesive sheet having separators on both surfaces of an adhesive is produced. Next, the adhesive sheet is cut to a desired shape. One separator is then removed from the cut adhesive sheet, and the exposed adhesive surface is bonded to a first adherend. Subsequently, the other separator is removed, and the exposed adhesive surface is bonded to a second adherend. With this method, part of the adhesive sheet is discarded after cutting, producing waste. In addition, air bubbles may be trapped at the bonding interface.

In view of the situation, methods have been studied in which no adhesive sheet is produced and an adhesive composition is printed in a predetermined shape before being bonded to an adherend. These methods can reduce waste production and also prevent air bubbles at the bonding interface.

For example, Patent Literature 1 discloses an invention to provide a radiation curable adhesive composition that allows fine patterning and exhibits high adhesion to various adherends such as metals and plastics. The radiation curable adhesive resin composition contains 10 to 70% by weight of an ethylenically unsaturated monomer not containing an aromatic ring, 1 to 10% by weight of a photopolymerization initiator, and 10 to 55% by weight of a crosslinking agent, wherein the composition contains 10 to 45% by weight of an alkyl (meth)acrylate having a C8-C18 alkyl group as the ethylenically unsaturated monomer not containing an aromatic ring and 10 to 50% by weight of a urethane poly(meth)acrylate having a weight average molecular weight of 20,000 to 100,000 as the crosslinking agent.

Patent Literature 2 discloses an invention to provide a photocurable adhesive composition that, even when irradiated with light in the presence of oxygen, gives a laminate having adhesive strength equivalent to that in the absence of oxygen. The photocurable adhesive composition contains (A) a (meth)acrylate oligomer, (B) a monofunctional (meth)acrylate monomer, (C) a bi- to tetra-functional (meth)acrylate monomer, (D) a photoreaction initiator, (E) a tackifier having a softening point of 70° C. to 150° C., and (F) a liquid plasticizer.

Adhesive sheets may contain fillers. For example, Patent Literature 3 discloses an invention of a flame-retardant, thermally conductive, electrically insulating pressure-sensitive adhesive composition containing: a) a (meth)alkyl acrylate monomer having a C1-C14 alkyl group; b) a photopolymerization initiator; c) 300 to 700 parts by mass of thermally conductive, electrically insulating particles, 200 parts by mass or more of which are flame-retardant; and d) 0.05 to 5.0% by mass of a polymeric dispersant relative to the thermally conductive, electrically insulating particles.

Patent Literature 4 discloses an invention of a flame-retardant thermally conductive adhesive sheet including a flame-retardant thermally conductive adhesive layer. The adhesive layer contains at least (a) an acrylic polymer obtained by copolymerizing a monomer component containing an alkyl (meth)acrylate as a main component, a polar group-containing monomer, and substantially no carboxy group-containing monomer and (b) a hydrated metal compound.

### CITATION LIST

### Patent Literature

Patent Literature 1: JP 2013-216742 A

Patent Literature 2: WO 2016/163152

Patent Literature 3: JP 2004-59851 A

Patent Literature 4: JP 2012-180495 A

### SUMMARY OF INVENTION

### Technical Problem

As described above, the methods in which no adhesive sheet is produced and an adhesive composition is printed in a predetermined shape before being bonded to an adherend can reduce waste production and also prevent air bubbles at the bonding interface. The adhesive composition is preferably cured with UV light to avoid heating adherends. However, curing the adhesive composition exposed and not covered with a separator may result in insufficient UV reactivity and insufficient adhesion to substrates. Moreover, filling the adhesive composition with a thermally conductive filler to dissipate heat generated in an electronic component reduces the UV transmittance, which may further reduce the UV reactivity. There is thus still room for improvement to provide a UV-curable heat-dissipating resin composition that has excellent printability, excellent heat dissipation properties, and excellent adhesion to various substrates.

The present invention aims to provide a UV-curable heat-dissipating resin composition having excellent printability, excellent heat dissipation properties, and excellent adhesion to various substrates. The present invention also aims to provide a heat-dissipating adhesive sheet containing the UV-curable heat-dissipating resin composition, a laminate, and a method for producing a laminate.

### Solution to Problem

The present disclosure 1 relates to a UV-curable heat-dissipating resin composition containing: (A) a nitrogen-containing monomer; (B) a monofunctional (meth)acrylate monomer; (C) a crosslinking component; (D) a photopolymerization initiator; and (E) a thermally conductive filler having a thermal conductivity of 3 W/m·K or higher, the thermally conductive filler (E) being contained in an amount of 20 to 70% by volume, the nitrogen-containing monomer (A) being contained in an amount of 10 to 35% by weight relative to a whole amount of the composition excluding the thermally conductive filler (E).

The present disclosure 2 relates to the UV-curable heat-dissipating resin composition of the present disclosure 1, further containing a nonreactive component having no reactivity with the nitrogen-containing monomer (A) nor with the monofunctional (meth)acrylate monomer (B).

The present disclosure 3 relates to the UV-curable heat-dissipating resin composition of the present disclosure 2, wherein the nonreactive component is contained in a ratio of 0.1 to 140 parts by weight to 100 parts by weight of a total amount of the nitrogen-containing monomer (A) and the monofunctional (meth)acrylate monomer (B).

The present disclosure 4 relates to the UV-curable heat-dissipating resin composition of the present disclosure 2 or 3, wherein the nonreactive component contains at least one of a thermoplastic resin or a tackifier.

The present disclosure 5 relates to the UV-curable heat-dissipating resin composition of any one of the present disclosures 1 to 4, wherein the nitrogen-containing monomer (A) includes a monomer having a negative e value.

The present disclosure 6 relates to the UV-curable heat-dissipating resin composition of any one of the present disclosures 2 to 5, wherein the crosslinking component (C) has reactivity with the nitrogen-containing monomer (A) and the monofunctional (meth)acrylate monomer (B) or has reactivity with the nitrogen-containing monomer (A), the monofunctional (meth)acrylate monomer (B), and the nonreactive component.

The present disclosure 7 relates to the UV-curable heat-dissipating resin composition of any one of the present disclosures 1 to 6, wherein the crosslinking component (C) has at least one binding functional group selected from the group consisting of an isocyanate group, an epoxy group, an aldehyde group, a hydroxy group, an amino group, a (meth)acrylate group, and a vinyl group.

The present disclosure 8 relates to the UV-curable heat-dissipating resin composition of any one of the present disclosures 1 to 7, wherein the crosslinking component (C) contains a (meth)acrylate monomer that in a form of a homopolymer has a gel fraction of 80% or higher.

The present disclosure 9 relates to the UV-curable heat-dissipating resin composition of any one of the present disclosures 1 to 8, wherein the crosslinking component (C) is a (meth)acrylate monomer having a viscosity at 25° C. of 10,000 cps or higher and is contained in an amount of 0.1 to 25% by weight in 100% by weight of a total amount of the nitrogen-containing monomer (A), the monofunctional (meth)acrylate monomer (B), and the crosslinking component (C).

The present disclosure 10 relates to the UV-curable heat-dissipating resin composition of any one of the present disclosures 1 to 9, wherein the thermally conductive filler (E) is an inorganic filler containing at least one compound selected from the group consisting of a metal oxide, a metal hydroxide, a metal nitride, a metal carbide, and a metal boride.

The present disclosure 11 relates to the UV-curable heat-dissipating resin composition of any one of the present disclosures 1 to 10, which has a thermal conductivity of 0.30 W/m·K or higher after being cured.

The present disclosure 12 relates to the UV-curable heat-dissipating resin composition of any one of the present disclosures 1 to 11, further containing a dispersant in an amount of 0.01 to 5.0% by weight relative to 100% by weight of the thermally conductive filler (E).

The present disclosure 13 relates to the UV-curable heat-dissipating resin composition of any one of the present disclosures 1 to 12, wherein the photopolymerization initiator (D) is contained in an amount of 0.2 to 10 parts by weight relative to 100 parts by weight of a total amount of the nitrogen-containing monomer (A) and the monofunctional (meth)acrylate monomer (B).

The present disclosure 14 relates to a heat-dissipating adhesive sheet including: a substrate; and a heat-dissipating adhesive layer on at least one surface of the substrate, the heat-dissipating adhesive layer containing the UV-curable heat-dissipating resin composition of any one of the present disclosures 1 to 13.

The present disclosure 15 relates to the heat-dissipating adhesive sheet of the present disclosure 14, wherein the heat-dissipating adhesive layer is disposed on part of the substrate.

The present disclosure 16 relates to a laminate including a first adherend and a second adherend bonded to each other with the heat-dissipating adhesive layer of the heat-dissipating adhesive sheet of the present disclosure 14 or 15.

The present disclosure 17 relates to a method for producing a laminate, including: applying the UV-curable heat-dissipating resin composition of any one of the present disclosures 1 to 13 to a first adherend; exposing the UV-curable heat-dissipating resin composition to light to form a heat-dissipating adhesive layer; and bonding a second adherend to the heat-dissipating adhesive layer to form a laminate.

The present disclosure 18 relates to the method for producing a laminate of the present disclosure 17, wherein the UV-curable heat-dissipating resin composition is applied by ink-jet printing, screen printing, spray coating, or spin coating, and the UV-curable heat-dissipating resin composition is applied to part of the first adherend.

The present invention is described in detail below.

The present inventors have found out that it is difficult for conventional adhesive compositions to have sufficient UV reactivity when they are exposed and not covered with a separator during curing. The inventors also have found out that filling such compositions with (E) a thermally conductive filler for heat dissipation properties may reduce the UV transmittance, which may further reduce the UV reactivity. After further studies, the inventors have found out that using a specific amount of (A) a nitrogen-containing monomer makes it possible to achieve sufficient UV reactivity while adding a large amount of the thermally conductive filler (E) to ensure heat dissipation properties. The inventors also have found out that combined use of the nitrogen-containing monomer (A) and the thermally conductive filler (E) with (B) a monofunctional (meth)acrylate monomer and (C) a crosslinking component can ensure the printability and the adhesion to various substrates. The inventors thus completed the present invention.

The UV-curable heat-dissipating resin composition contains (A) a nitrogen-containing monomer. The nitrogen-containing monomer may be any monomer having a nitrogen atom and a polymerizable group in the molecule. The nitrogen-containing monomer is preferably an amide compound having a vinyl group, more preferably a cyclic amide compound having a vinyl group, still more preferably a compound having a lactam structure.

Examples of the amide compound having a vinyl group include N-vinylacetamide and (meth)acrylamide compounds. Examples of the (meth)acrylamide compounds include N, N-dimethyl (meth)acrylamide, N-(meth)acryloylmorpholine, N-hydroxyethyl(meth)acrylamide, N, N-diethyl (meth)acrylamide, N-isopropyl(meth)acrylamide, and N, N-dimethylaminopropyl(meth)acrylamide.

Examples of the cyclic amide compound having a vinyl group include compounds represented by the following formula (1).

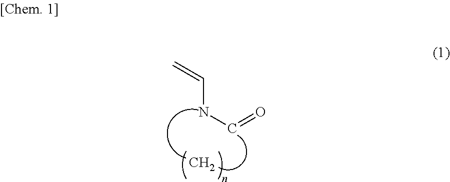

In the formula (1), n represents an integer of 2 to 6.

Examples of the compounds represented by the formula (1) include N-vinyl-2-pyrrolidone and N-vinyl-ε-caprolactam. In particular, N-vinyl-ε-caprolactam is preferred.

The nitrogen-containing monomer preferably includes a monomer having a negative e value. Examples of the monomer having a negative e value include N-vinylacetamide (e value=−1.57), N-vinyl-ε-caprolactam (e value=−1.18), N-vinyl-2-pyrrolidone (e value=−1.62), and N, N-dimethyl(meth)acrylamide (e value=−0.26).

The amount of the nitrogen-containing monomer (A) is 10 to 35% by weight relative to the whole amount of the composition excluding the thermally conductive filler (E). With the amount of the nitrogen-containing monomer of 10% by weight or more, sufficient UV reactivity can be obtained even when a coating film containing the thermally conductive filler is irradiated with UV light in the presence of oxygen without the upper surface of the coating film being covered with a separator. With the amount of the nitrogen-containing monomer of 35% by weight or less, the resulting adhesive can have excellent adhesion to various substrates. The lower limit of the amount of the nitrogen-containing monomer is more preferably 12% by weight, and the upper limit thereof is more preferably 30% by weight.

The UV-curable heat-dissipating resin composition contains (B) a monofunctional (meth)acrylate monomer.

The “(meth)acryl” herein means acryl or methacryl. The “(meth)acrylate monomer” means a monomer having a (meth)acryloyl group. The “(meth)acryloyl” means acryloyl or methacryloyl. The “monofunctional” herein means containing one (meth)acryloyl group in one monomer molecule. Here, a monomer having a (meth)acryloyl group and nitrogen is not treated as the monofunctional (meth)acrylate monomer (B) but treated as the nitrogen-containing monomer (A).

Examples of the (meth)acrylate monomer include (meth)acrylate compounds and epoxy (meth)acrylates.

The “(meth)acrylate” herein means acrylate or methacrylate. The “epoxy (meth)acrylate” means a compound obtained by reacting all the epoxy groups in an epoxy compound with (meth) acrylic acid.

Examples of monofunctional (meth)acrylate compounds include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, isooctyl (meth)acrylate, isononyl (meth)acrylate, isodecyl (meth)acrylate, lauryl (meth)acrylate, isomyristyl (meth)acrylate, stearyl (meth)acrylate, 2-hydroxyethyl (meth)acrylate, 2-hydroxypropyl (meth)acrylate, 2-hydroxy-3-phenoxypropyl (meth)acrylate, 2-hydroxybutyl (meth)acrylate, 4-hydroxybutyl (meth)acrylate, cyclohexyl (meth)acrylate, isobornyl (meth)acrylate, bicyclopentenyl (meth)acrylate, benzyl (meth)acrylate, 2-methoxyethyl (meth)acrylate, 2-ethoxyethyl (meth)acrylate, 2-butoxyethyl (meth)acrylate, 2-phenoxyethyl (meth)acrylate, methoxyethylene glycol (meth)acrylate, methoxypolyethylene glycol (meth)acrylate, phenoxydiethylene glycol (meth)acrylate, phenoxypolyethylene glycol (meth)acrylate, tetrahydrofurfuryl (meth)acrylate, tetrahydrofurfuryl alcohol acrylic acid multimer ester, ethyl carbitol (meth)acrylate, 2,2,2,-trifluoroethyl (meth)acrylate, 2,2,3,3-tetrafluoropropyl (meth)acrylate, 1H, 1H, 5H-octafluoropentyl (meth)acrylate, imide (meth)acrylate, dimethylaminoethyl (meth)acrylate, diethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropylphthalate, 2-(meth)acryloyloxyethyl phosphate, (3-ethyloxetan-3-yl) methyl (meth)acrylate, 2-(((butylamino)carbonyl)oxy)ethyl (meth)acrylate, (3-propyloxetan-3-yl)methyl(meth)acrylate, (3-butyloxetan-3-yl)methyl(meth)acrylate, (3-ethyloxetan-3-yl)ethyl(meth)acrylate, (3-ethyloxetan-3-yl) propyl(meth)acrylate, (3-ethyloxetan-3-yl) butyl (meth)acrylate, (3-ethyloxetan-3-yl)pentyl(meth)acrylate, (3-ethyloxetan-3-yl)hexyl(meth)acrylate, γ-butyrolactone (meth)acrylate, (2,2-dimethyl-1,3-dioxolan-4-yl)methyl (meth)acrylate, (2-methyl-2-ethyl-1,3-dioxolan-4-yl)methyl (meth)acrylate, (2-methyl-2-isobutyl-1,3-dioxolan-4-yl) methyl (meth)acrylate, (2-cyclohexyl-1,3-dioxolan-4-yl) methyl (meth)acrylate, and cyclic trimethylolpropane formal acrylate.

Examples of the epoxy (meth)acrylates include bisphenol A epoxy (meth)acrylate, bisphenol F epoxy (meth)acrylate, bisphenol E epoxy (meth)acrylate, and caprolactone-modified products of these.

The lower limit of the amount of the monofunctional (meth)acrylate monomer (B) in 100 parts by weight of the whole amount of the composition excluding the thermally conductive filler (E) is preferably 20 parts by weight, and the upper limit thereof is preferably 70 parts by weight. When the amount of the monofunctional (meth)acrylate monomer is 20 parts by weight or more, the resulting adhesive can have excellent adhesion to various substrates. When the amount of the monofunctional (meth)acrylate monomer is 70 parts by weight or less, the adhesive can be excellent in other properties than adhesion. The lower limit of the amount of the monofunctional (meth)acrylate monomer is more preferably 30 parts by weight, and the upper limit thereof is more preferably 60 parts by weight.

The UV-curable heat-dissipating resin composition contains (C) a crosslinking component. The crosslinking component may be any compound having two or more binding functional groups in one molecule. The crosslinking component is preferably one having reactivity with the nitrogen-containing monomer (A) and the monofunctional (meth)acrylate monomer (B) or one having reactivity with the nitrogen-containing monomer (A), the monofunctional (meth)acrylate monomer (B), and the later-described nonreactive component.

The crosslinking component (C) preferably has at least one binding functional group selected from the group consisting of an isocyanate group, an epoxy group, an aldehyde group, a hydroxy group, an amino group, a (meth)acrylate group, and a vinyl group. A crosslinking component having any of these binding functional groups can form crosslinking bonds at a sufficient density in curing.

The crosslinking component (C) preferably contains a (meth)acrylate monomer that in the form of a homopolymer has a gel fraction of 80% or higher. Using such a (meth)acrylate monomer can improve the cohesive force of the UV-curable heat-dissipating resin composition, improving the printability of the composition and the adhesion of the resulting heat-dissipating adhesive layer.

The crosslinking component (C) preferably contains a (meth)acrylate monomer having a viscosity at 25° C. of 10,000 cps or higher. The crosslinking component (C) preferably contains a bifunctional (meth)acrylate monomer. Using such a (meth)acrylate monomer can improve the cohesive force of the UV-curable heat-dissipating resin composition, improving the printability of the composition and the adhesion of the resulting heat-dissipating adhesive layer.

Specific examples of the crosslinking component (C) include: radically polymerizable polyfunctional oligomers and monomers; and polymers having a crosslinkable functional group.

Examples of the radically polymerizable polyfunctional oligomers and monomers include trimethylolpropane triacrylate, tetramethylolmethane tetraacrylate, pentaerythritol triacrylate, pentaerythritol tetraacrylate, dipentaerythritol monohydroxypentaacrylate, dipentaerythritol hexaacrylate, and methacrylates of the same kinds. Other examples include 1,4-butylene glycol diacrylate, 1,6-hexanediol diacrylate, polyethylene glycol diacrylate, commercial oligoester acrylates, and methacrylates of the same kinds. These radically polymerizable polyfunctional oligomers and monomers may be used alone or in combination of two or more thereof.

The amount of the crosslinking component (C) is preferably 0.1 to 25% by weight in 100% by weight of the total amount of the nitrogen-containing monomer (A), the monofunctional (meth)acrylate monomer (B), and the crosslinking component (C). When the amount of the crosslinking component (C) is within the range, the cohesive force of the UV-curable heat-dissipating resin composition can be appropriately improved, and the printability of the composition and the adhesion of the resulting heat-dissipating adhesive layer can be improved. The lower limit of the amount of the crosslinking component (C) is more preferably 0.5% by weight, and the upper limit thereof is more preferably 15% by weight.

The UV-curable heat-dissipating resin composition contains (D) a photopolymerization initiator.

The photopolymerization initiator is preferably a photoradical polymerization initiator. The photopolymerization initiator and the photoradical polymerization initiator may be used alone or in combination of two or more thereof.

Examples of the photoradical polymerization initiator include benzophenone compounds, alkylphenone compounds, acylphosphine oxide compounds, titanocene compounds, oxime ester compounds, benzoin ether compounds, and thioxanthone compounds. Examples of the alkylphenone compounds include acetophenone compounds.

Specific examples of the photoradical polymerization initiator include 1-hydroxycyclohexyl phenyl ketone, 2-benzyl-2-(dimethylamino)-1-(4-((morpholino)phenyl)-1-butanone, 2-(dimethylamino)-2-((4-methylphenyl)methyl)-1-(4-(4-morpholinyl)phenyl)-1-butanone, 2,2-dimethoxy-1,2-diphenylethan-1-one, bis(2,4,6-trimethylbenzoyl) phenylphosphine oxide, 2-methyl-1-(4-methylthiophenyl)-2-morpholinopropan-1-one, 1-(4-(2-hydroxyethoxy)-phenyl)-2-hydroxy-2-methyl-1-propan-1-one, 1-(4-(phenylthio)phenyl)-1,2-octanedione-2-(O-benzoyl oxime), 2,4,6-trimethylbenzoyl diphenylphosphine oxide, benzoin methyl ether, benzoin ethyl ether, and benzoin isopropyl ether.

The lower limit of the amount of the photopolymerization initiator (D) is preferably 0.2 parts by weight, and the upper limit thereof is preferably 10 parts by weight, relative to 100 parts by weight of the total amount of the nitrogen-containing monomer (A) and the monofunctional (meth)acrylate monomer (B). When the amount of the photopolymerization initiator is within the range, the resulting UV-curable heat-dissipating resin composition can have excellent UV curability while maintaining excellent storage stability. The lower limit of the amount of the photopolymerization initiator is more preferably 0.5 parts by weight, and the upper limit thereof is more preferably 3 parts by weight, still more preferably 2.5 parts by weight, particularly preferably 2 parts by weight. When two or more photopolymerization initiators are contained, the amount of the photopolymerization initiator refers to the total amount of all the photopolymerization initiators contained.

The UV-curable heat-dissipating resin composition contains (E) a thermally conductive filler having a thermal conductivity of 3 W/m·K or higher. The thermally conductive filler (E) may have any thermal conductivity, but it is preferably 10 W/m·K or higher, more preferably 20 W/m·K or higher, still more preferably 30 W/m·K or higher. The upper limit of the thermal conductivity is not limited because the higher the thermal conductivity of the thermally conductive filler (E), the better. For conventionally known thermally conductive fillers, the upper limit of the thermal conductivity is around 3,000 W/m·K.

The thermally conductive filler (E) may be made of any material. Examples include carbides, nitrides, oxides, hydroxides, metals, carbon materials, and silicate minerals.

Examples of the carbides include silicon carbide, boron carbide, aluminum carbide, titanium carbide, and tungsten carbide.

Examples of the nitrides include silicon nitride, boron nitride, boron nitride nanotubes, aluminum nitride, gallium nitride, chromium nitride, tungsten nitride, magnesium nitride, molybdenum nitride, and lithium nitride.

Examples of the oxides include silicon oxide (silica), aluminum oxide (alumina) (including aluminum oxide hydrate (e.g., boehmite)), magnesium oxide, titanium oxide, cerium oxide, and zirconium oxide. Examples of the oxides also include transition metal oxides such as barium titanate, as well as metal ion-doped oxides such as indium tin oxide and antimony tin oxide.

Examples of the hydroxides include aluminum hydroxide, calcium hydroxide, and magnesium hydroxide.

Examples of the metals include copper, gold, nickel, tin, iron, and alloys thereof.

Examples of the carbon materials include carbon black, graphite, diamond, graphene, fullerene, carbon nanotubes, carbon nanofibers, carbon nanohorns, carbon microcoils, and carbon nanocoils.

Examples of the silicate minerals include talc.

The thermally conductive filler (E) is preferably an inorganic filler containing at least one compound selected from the group consisting of a metal oxide, a metal hydroxide, a metal nitride, a metal carbide, and a metal boride. Preferred among these are alumina, aluminum hydroxide, aluminum nitride, and zinc oxide. These inorganic fillers can ensure electrical insulation while providing excellent heat conductivity.

The thermally conductive filler (E) may have any shape. It may be a spherical filler or a non-spherical filler.

One thermally conductive filler may be used alone, or two or more thermally conductive fillers may be used in combination. To effectively enhance the heat dissipation properties, two or more thermally conductive fillers having different average particle sizes are preferably used in combination. Specifically, the thermally conductive filler preferably contains a small-particle-size thermally conductive filler having an average particle size of 0.1 μm or greater and 1.5 μm or less and a large-particle-size thermally conductive filler having an average particle size of greater than 1.5 μm. When a small-particle-size thermally conductive filler and a large-particle-size thermally conductive filler are used in combination, the amount of the large-particle-size thermally conductive filler in the composition is preferably equal to or more than that of the small-particle-size thermally conductive filler. The ratio of the amount of the large-particle-size thermally conductive filler to the amount of the small-particle-size thermally conductive filler (amount of large-particle-size thermally conductive filler/amount of small-particle-size thermally conductive filler) is preferably 1 or greater, more preferably 1.5 or greater, still more preferably 2 or greater, and particularly preferably 10 or less.

The UV-curable heat-dissipating resin composition can be determined to contain two or more thermally conductive fillers having different average particle sizes when two or more peaks appear in the thermally conductive filler particle size distribution.

The amount of the thermally conductive filler (E) is 20 to 70% by volume relative to the total volume of the UV-curable heat-dissipating resin composition. When the amount of the thermally conductive filler (E) is within the range, excellent heat conductivity can be obtained. The amount of the thermally conductive filler (E) can be increased up to 70% by volume because the nitrogen-containing monomer (A) is compounded. The lower limit of the amount of the thermally conductive filler is more preferably 20% by volume, and the upper limit thereof is more preferably 65% by volume. The lower limit is still more preferably 30% by volume, and the upper limit is still more preferably 60% by volume.

The UV-curable heat-dissipating resin composition preferably contains a nonreactive component having no reactivity with the nitrogen-containing monomer (A) nor with the monofunctional (meth)acrylate monomer (B). The nonreactive component may be a compound containing no reactive double bond therein or a compound containing a reactive double bond but showing substantially no photopolymerizability. When containing the nonreactive component, the UV-curable heat-dissipating resin composition can have improved cohesive force, so that the composition can form a thick coating film and have excellent printability. The nonreactive component may show reactivity with a trigger such as heat or moisture after the UV-curable heat-dissipating resin composition is photopolymerized. For example, the nonreactive component may contain an epoxy resin to be cured by heat or may contain an isocyanate compound to be cured by moisture or alcohol.

The nonreactive component preferably contains at least one of a thermoplastic resin or a tackifier.

Specific examples of the thermoplastic resin include plasticizers such as organic acid esters, organophosphate esters, and organophosphite esters, and solvent-free acrylic polymers.

Examples of the plasticizers include organic acid ester plasticizers such as monobasic organic acid esters and polybasic organic acid esters and phosphoric acid plasticizers such as organophosphate plasticizers and organophosphite plasticizers. Preferred among these are organic acid ester plasticizers. These plasticizers may be used alone or in combination of two or more thereof.

Examples of the organic acid esters include monobasic organic acid esters and polybasic organic acid esters.

Non-limiting examples of the monobasic organic acid esters include glycol esters obtained by reaction between a monobasic organic acid (e.g., butyric acid, isobutyric acid, caproic acid, 2-ethyl butyric acid, heptylic acid, n-octylic acid, 2-ethylhexanoic acid, pelargonic acid (n-nonylic acid), or decylic acid) and a glycol (e.g., triethylene glycol, tetraethylene glycol, or tripropylene glycol).

Non-limiting examples of the polybasic organic acid esters include ester compounds obtained by reaction between a polybasic organic acid (e.g., adipic acid, sebacic acid, or azelaic acid) and a C4-C8 linear or branched alcohol.

Specific examples of the organic acid esters include triethylene glycol-di-2-ethylbutyrate (3GH), triethylene glycol-di-2-ethylhexanoate (3GO), triethylene glycol dicaprylate, triethylene glycol di-n-octanoate, and triethylene glycol-di-n-heptanoate (3G7). Examples also include tetraethylene glycol-di-n-heptanoate (4G7), tetraethylene glycol-di-2-ethylhexanoate, dibutyl sebacate, dioctyl azelate, dibutyl carbitol adipate, ethylene glycol di-2-ethylbutyrate, and 1,3-propylene glycol di-2-ethylbutyrate. Examples further include 1,4-butylene glycol di-2-ethylbutyrate, diethylene glycol-di-2-ethylbutyrate, diethylene glycol-di-2-ethylhexanoate, and dipropylene glycol-di-2-ethylbutyrate. Examples further include triethylene glycol di-2-ethylpentanoate, tetraethylene glycol-di-2-ethylbutyrate (4GH), diethylene glycol dicaprylate, dihexyl adipate (DHA), dioctyl adipate, hexyl cyclohexyl adipate, diisononyl adipate, and heptyl nonyl adipate. Examples also include oil-modified sebacic alkyds, mixtures of phosphates and adipates, and mixed type adipates prepared from C4-C9 alkyl alcohols and C4-C9 cyclic alcohols.

The organophosphate ester or organophosphite ester may be a compound obtained by condensation reaction between phosphoric acid or phosphorous acid and an alcohol. In particular, preferred is a compound obtained by condensation reaction between a C1-C12 alcohol and phosphoric acid or phosphorous acid. Examples of the C1-C12 alcohol include methanol, ethanol, butanol, hexanol, 2-ethyl butanol, heptanol, octanol, 2-ethylhexanol, decanol, dodecanol, butoxy ethanol, butoxyethoxy ethanol, benzyl alcohol.

Specific examples of the organophosphate ester or organophosphite ester include trimethyl phosphate, triethyl phosphate, tripropyl phosphate, tributyl phosphate, tri(2-ethylhexyl) phosphate, tri (butoxyethyl) phosphate, tri(2-ethylhexyl) phosphite, isodecylphenyl phosphate, and triisopropyl phosphate.

Examples of the solvent-free acrylic polymers include: polymers of at least one monomer selected from alkyl (meth)acrylates having a C1-C20 alkyl group; and copolymers of this monomer and other copolymerizable monomer(s).

Examples of commercial solvent-free acrylic polymers include ARUFON UP-1000 series, UH-2000 series, and UC-3000 series available from Toagosei Co., Ltd.

Examples of the tackifier include rosin resins and terpene resins.

The rosin resin may be, for example, a rosin diol.

The rosin diol may be any rosin-modified diol having two rosin skeletons and two hydroxy groups in the molecule. Diols having a rosin component in the molecule are generically referred to as rosin polyols. Rosin polyols are classified into the polyether type in which the skeleton excluding that of the rosin component is like polypropylene glycol (PPG) and the polyester type such as condensed polyester polyols, lactone-type polyester polyols, and polycarbonate diols.

Examples of the rosin diol include rosin esters obtained by reaction between a rosin and a polyhydric alcohol, epoxy-modified rosin esters obtained by reaction between a rosin and an epoxy compound, and modified rosins having a hydroxy group such as polyethers having a rosin skeleton. These can be produced by a conventionally known method.

Examples of the rosin component include abietic acid and its derivatives (e.g., dehydroabietic acid, dihydroabietic acid, tetrahydroabietic acid, diabietic acid, neoabietic acid), pimaric acid-type resin acids such as levopimaric acid, hydrogenated rosins obtained by hydrogenation of these, and disproportionated rosins obtained by disproportionation of these.

Examples of commercial products of the rosin resin include Pine crystal series (D-6011, KE-615-3, KR-614, KE-100, KE-311, KE-359, KE-604, D-6250) available from Arakawa Chemical Industries, Ltd.

Examples of the terpene resin include terpene phenolic resins.

The terpene phenolic resin is a copolymer of a phenol and a terpene resin that is an essential oil constituent obtained from natural products such as turpentine or orange peels, and includes a partially hydrogenated terpene phenolic resin obtained by partially hydrogenating the copolymer and a fully hydrogenated terpene phenolic resin obtained by fully hydrogenating the copolymer.

Here, the fully hydrogenated terpene phenolic resin refers to a terpene resin (tackifier resin) obtained by substantially fully hydrogenating a terpene phenolic resin. The partially hydrogenated terpene phenolic resin refers to a terpene resin (tackifier resin) obtained by partially hydrogenating a terpene phenolic resin. The terpene phenolic resin has a terpene-derived double bond and a phenol-derived aromatic ring double bond. Accordingly, the fully hydrogenated terpene phenolic resin means a tackifier resin in which both the terpene site and phenol site are fully or mostly hydrogenated. The partially hydrogenated terpene phenolic resin means a terpene phenolic resin in which the hydrogenation of these sites is not fully but partially performed. Any hydrogenation method and any reaction type may be employed.

Examples of the commercial products of the terpene phenolic resin include YS POLYSTER NH (fully hydrogenated terpene phenolic resin) available from Yasuhara Chemical Co., Ltd.

The amount of the nonreactive component is preferably in a ratio of 0.1 to 140 parts by weight to 100 parts by weight of the total amount of the nitrogen-containing monomer (A) and the monofunctional (meth)acrylate monomer (B). When the amount of the nonreactive component is within the range, the UV-curable heat-dissipating resin composition can have improved cohesive force, so that the composition can form a thick coating film, have excellent printability, and also reduce a decrease in adhesiveness at high temperature. The lower limit of the amount of the nonreactive component is more preferably 5 parts by weight, and the upper limit thereof is more preferably 90 parts by weight.

The UV-curable heat-dissipating resin composition preferably contains a dispersant for stable dispersion of the thermally conductive filler without aggregation. Non-limiting examples of the dispersant include fatty acids, aliphatic amines, alkanolamides, and phosphates.

Non-limiting examples of the fatty acids include: saturated fatty acids such as behenic acid, stearic acid, palmitic acid, myristic acid, lauric acid, capric acid, caprylic acid, and coconut fatty acid; and unsaturated fatty acids such as oleic acid, linoleic acid, linolenic acid, sorbic acid, tallow fatty acid, and hydroxystearic acid. Preferred among these are lauric acid, stearic acid, and oleic acid.

Non-limiting examples of the aliphatic amines include laurylamine, myristylamine, cetylamine, stearylamine, oleylamine, (coco) alkylamine, (hydrogenated tallow) alkylamine, (tallow) alkylamine, and (soya) alkylamine.

Non-limiting examples of the alkanolamides include coconut fatty acid diethanolamide, tallow fatty acid diethanolamide, lauric acid diethanolamide, and oleic acid diethanolamide.

Non-limiting examples of the phosphates include polyoxyethylene alkyl ether phosphate and polyoxyethylene alkyl allyl ether phosphate.

The amount of the dispersant is preferably 0.01 to 5.0% by weight relative to 100% by weight of the thermally conductive filler (E). When the amount of the dispersant is within the range, the dispersibility of the thermally conductive filler (E) can be improved, and excellent printability can be obtained. The lower limit of the amount of the dispersant is more preferably 0.05% by weight, and the upper limit thereof is more preferably 1% by weight.

The UV-curable heat-dissipating resin composition may contain a defoamer. Non-limiting examples of the defoamer include silicone defoamers, acrylic polymer defoamers, vinyl ether polymer defoamers, and olefin polymer defoamers.

The UV-curable heat-dissipating resin composition may further contain a known additive such as a viscosity modifier, a silane coupling agent, a sensitizer, a heat-curing agent, a curing retardant, an antioxidant, or a storage stabilizer, as long as the purposes of the present invention are not impaired. To prevent a reduction in UV reactivity of the UV-curable heat-dissipating resin composition, the UV-curable heat-dissipating resin composition preferably contains substantially no organic solvent. Specifically, the amount of the organic solvent is preferably 18 by weight or less relative to 100% by weight of the UV-curable heat-dissipating resin composition.

For the resulting heat-dissipating adhesive sheet to have good heat dissipation properties, the UV-curable heat-dissipating resin composition after being cured preferably has a thermal conductivity of 0.30 W/m·K or higher, more preferably 0.50 W/m·K or higher.

The UV-curable heat-dissipating resin composition may have any viscosity. The UV-curable heat-dissipating resin composition is preferably a paste having a viscosity at 25° C. of 0.1 to 500 Pa·s as measured using an E-type viscometer. The lower limit of the viscosity is more preferably 1 Pa·s, and the upper limit thereof is more preferably 450 Pa·s.

The viscosity can be measured using VISCOMETER TV-22 (available from Toki Sangyo Co., Ltd.) as an E-type viscometer with a CP1 cone plate by appropriately selecting a rotation rate of 1 to 100 rpm based on an optimal torque for each viscosity range.

The UV-curable heat-dissipating resin composition may be prepared by any method. For example, the UV-curable heat-dissipating resin composition may be prepared by a method of mixing the nitrogen-containing monomer (A), the monofunctional (meth)acrylate monomer (B), the crosslinking component (C), the photopolymerization initiator (D), the thermally conductive filler (E), and optional additives using a mixing device. Examples of the mixing device include a homogenizing disperser, a homogenizer, a universal mixer, a planetary mixer, a kneader, and a triple roll mill.

The method of use of the UV-curable heat-dissipating resin composition is not limited, but it is suitable for printing. Applying the composition in a desired pattern by printing on an adherend (substrate) to form a heat-dissipating adhesive layer has the advantage of eliminating the cutting process, as compared with producing an adhesive in a desired shape by cutting an adhesive sheet immediately before bonding. This results in reduced waste production and reduced environmental load. The method for printing is not limited. Examples thereof include screen printing, ink-jet printing, and gravure printing. Preferred among these is screen printing.

The UV-curable heat-dissipating resin composition forms a heat-dissipating adhesive layer when cured by UV irradiation. The UV-curable heat-dissipating resin composition may be used for a method of forming a heat-dissipating adhesive layer on a substrate (separator) to produce a heat-dissipating adhesive sheet transferrable onto an adherend, or a method of forming a heat-dissipating adhesive layer directly on an adherend. The method of forming a heat-dissipating adhesive layer directly on an adherend can minimize the number of times of bonding and also prevent air bubbles at the interface in bonding. The method of forming a heat-dissipating adhesive layer on a substrate (separator) has the advantage of having fewer restrictions on application because the heat-dissipating adhesive layer is disposed on an adherend by transfer.

In the following, a heat-dissipating adhesive sheet containing the UV-curable heat-dissipating resin composition, a laminate, and a method for producing a laminate are described.

The present invention also encompasses a heat-dissipating adhesive sheet including a substrate and a heat-dissipating adhesive layer on at least one surface of the substrate, the heat-dissipating adhesive layer containing the UV-curable heat-dissipating resin composition of the present invention.

The substrate is not limited, but it is preferably a resin film. Examples of a material of the resin film include polyester polymers such as polyethylene terephthalate and polyethylene naphthalate, cellulose polymers such as diacetyl cellulose and triacetyl cellulose, acrylic polymers such as polymethyl methacrylate, styrene polymers such as polystyrene and acrylonitrile-styrene copolymers (AS resins), and polycarbonate polymers. Examples of a transparent protective film include polyolefin polymers such as polyethylene, polypropylene, polyolefins having a cyclic or norbornene structure, and ethylene-propylene copolymers, vinyl chloride polymers, amide polymers such as nylons and aromatic polyamides, imide polymers, sulfone polymers, polyether sulfone polymers, polyetheretherketone polymers, polyphenylene sulfide polymers, vinyl alcohol polymers, vinylidene chloride polymers, vinyl butyral polymers, acrylate polymers, polyoxymethylene polymers, epoxy polymers, and mixture of these polymers. The substrate may have any thickness and may have a thickness of about 1 to 500 μm, for example.

The substrate is preferably release-treated so that it can be easily removed after the heat-dissipating adhesive layer is bonded to an adherend. For example, the substrate is preferably a release-treated polyethylene terephthalate (PET) sheet.

The heat-dissipating adhesive layer can be formed by applying the UV-curable heat-dissipating resin composition and then irradiating the composition with UV light. The heat-dissipating adhesive layer is preferably disposed on part of the substrate by a method such as printing.

The heat-dissipating adhesive layer preferably has a thickness of 50 μm or greater, more preferably 100 μm or greater. The heat-dissipating adhesive layer having a thickness of 50 μm or greater can have sufficient adhesion and can also conduct heat diffusely. The upper limit of the thickness of the heat-dissipating adhesive layer is not limited. The upper limit is preferably 1,000 μm or less, more preferably 500 μm or less for adaptation to reduced thickness of electronic devices.

With the heat-dissipating adhesive sheet, a laminate can be produced by bonding one surface (side not contacting the substrate) of the heat-dissipating adhesive layer to a first adherend, then removing the substrate, and bonding the other, exposed surface of the heat-dissipating adhesive layer to a second adherend. Examples of materials of the first adherend and the second adherend include metals such as stainless steel and aluminum and resins. Preferably, one of the first adherend and the second adherend is a heat-emitting electronic component, such as a power semiconductor chip, and the other of the first adherend and the second adherend is a heat-dissipating component. The present invention also encompasses a laminate including a first adherend and a second adherend bonded to each other with the heat-dissipating adhesive layer of the heat-dissipating adhesive sheet of the present invention.

The present invention also encompasses a method for producing a laminate, including: applying the UV-curable heat-dissipating resin composition of the present invention to a first adherend; exposing the UV-curable heat-dissipating resin composition to light to form a heat-dissipating adhesive layer; and bonding a second adherend to the heat-dissipating adhesive layer to form a laminate. The UV-curable heat-dissipating resin composition is preferably applied by ink-jet printing, screen printing, spray coating, or spin coating. The UV-curable heat-dissipating resin composition is preferably applied to part of the first adherend.

### Advantageous Effects of Invention

The present invention can provide a UV-curable heat-dissipating resin composition having excellent printability, excellent heat dissipation properties, and excellent adhesion to various substrates. The present invention can also provide a heat-dissipating adhesive sheet containing the UV-curable heat-dissipating resin composition, a laminate, and a method for producing a laminate.

### DESCRIPTION OF EMBODIMENTS

The present invention is described in more detail below with reference to examples. The present invention is not limited to these examples.

### Examples 1 to 20 and Comparative Examples 1 to 8

Materials were mixed using a planetary stirrer (available from Thinky Corporation, “Thinky Mixer”) in accordance with the formulations shown in Tables 1 and 2 to provide UV-curable heat-dissipating resin compositions of examples and comparative examples.

The following are the details of the materials expressed in abbreviations in the tables. The details of thermally conductive fillers are shown in Table 3.
NVC: N-vinyl-a-caprolactam (available from Tokyo Chemical Industry Co., Ltd.)
ACMO: acryloylmorpholine (available from KJ Chemicals Corporation)
DMAA: dimethylacrylamide (available from KJ Chemicals Corporation)
NVA: N-vinylacetamide (available from Showa Denko K.K.)
IDAA: isodecyl acrylate (available from Osaka Organic Chemical Industry Ltd.)
4HBA: 4-hydroxybutyl acrylate (available from Mitsubishi Chemical Corporation)
CN9004: urethane (bifunctional, available from Sartomer Japan Inc., “CN9004”)
EB3700: bisphenol A epoxy acrylate (bifunctional, available from Daicel-Allnex Ltd., “EBECRYL 3700”)
TPO: Omnirad TPO H (available from IGM Resins B.V)
819: Omnirad 819 (available from IGM Resins B.V)
184: Omnirad 184 (available from IGM Resins B.V)
KS-66: oil compound defoamer containing silicone oil compounded with silica fine powder (available from Shin-Etsu Silicones, “KS-66”)
BYK-111: dispersant (available from BYK Japan KK., “BYK-111”)
PE-590: rosin ester (available from Arakawa Chemical Industries Ltd., “PE-590”)
KE-311: rosin ester (available from Arakawa Chemical Industries Ltd., “KE-311”)

The acrylic polymer used as a thermoplastic resin in the examples and the comparative examples was prepared as follows.

A 2-L separable flask equipped with a thermometer, a stirrer, a nitrogen inlet tube, and a condenser was charged with 100 parts by weight of 2-ethylhexyl acrylate, 3 parts by weight of acrylic acid, 0.1 parts by weight of 2-hydroxyethyl acrylate, and 300 parts by weight of ethyl acetate as a polymerization solvent. Subsequently, nitrogen gas was blown into the reaction vessel for 30 minutes so that the air inside was purged with nitrogen, and the contents of the reaction vessel were heated to 80° C. with stirring. After 30 minutes, 0.5 parts by weight of t-butylperoxy-2-ethylhexanoate (one-hour half life temperature: 92.1° C., ten-hour half-life temperature: 72.1° C.) as a polymerization initiator was diluted with 5 parts by weight of ethyl acetate, and the obtained polymerization initiator solution was dripped into the reaction vessel over six hours. Thereafter, the reaction was further continued at 80° C. for six hours, and then the reaction solution was cooled to provide an acrylic polymer solution.

The obtained solution was diluted with a diluting solvent (solvent mixture of methanol and toluene, with a methanol/toluene weight ratio of 1:2) to provide a solution having a solid content of 20% by weight. Subsequently, this solution was applied to a release-treated PET film to a dried thickness of 100 μm with a coater, and dried at 80° C. for one hour and at 110° C. for one hour, whereby an acrylic polymer was obtained.

### Evaluation

The UV-curable heat-dissipating resin compositions of Examples 1 to 20 and Comparative Examples 1 to 8 and cured products of the compositions were evaluated as follows. Tables 1, 2, and 4 show the results.

The cured products used for evaluation were produced as follows.

### Production of Cured Product

The UV-curable heat-dissipating resin compositions were each applied with an applicator to a thickness of 150 μm to a PET sheet having one release-treated surface (available from Nippa Corporation, “1-E”, thickness 50 μm). Subsequently, without sealing the upper surface of the applied composition, the composition was irradiated with UV light with an irradiation energy of 900 mJ/cm² in an atmospheric environment using an LED curing device (available from Gro-up, “GUC-584M”) set to a UV irradiance of 300 mW/cm² at a wavelength of 365 nm. The UV-curable heat-dissipating resin composition was thereby cured to provide a cured product.

### Thermal Conductivity

The cured products of the UV-curable heat-dissipating resin compositions were each cut to a size of 5 cm×10 cm and used to measure the thermal conductivity with Quick Thermal Conductivity Meter (available from Kyoto Electronics Manufacturing Co., Ltd., “QTM500”) at an ambient temperature of 23° C.±2° C.

### Printability Test

### (1) Screen Printability

The UV-curable heat-dissipating resin compositions were each evaluated for screen printability using a screen printer (“SSA-PC560E”, available from Seria Corporation). The UV-curable heat-dissipating resin compositions were each printed on a PET sheet (available from Nippa Corporation “1-E”, thickness 50 μm) to form a pattern having a thickness of 100 μm and a width of 1,000 μm using a patterned 3D-80 mesh printing plate. The printed composition was irradiated with UV light with an irradiation energy of 900 mJ/cm² using an LED curing device (available from Gro-up, “GUC-584M”) set to a UV irradiance of 300 W/cm² at a wavelength of 365 nm, whereby a cured product was obtained. The state of the cured product was observed and evaluated in accordance with the following criteria.

### (2) Dispensing Application Properties

The UV-curable heat-dissipating resin compositions were each applied at a thickness of 100 μm and a width of 1,000 μm using a dispenser device (available from Musashi Engineering, Inc., “SHOTMASTER-300”), and irradiated with UV light in the same manner as above to provide a cured product. The state of the cured product was observed and evaluated in accordance with the following criteria.

### Air Bubbles

◯ (Good): No air bubble was formed in the coating film.
x (Poor): An air bubble was formed in the coating film.

### Film Thickness

◯ (Good): A coating film thickness of 100 μm was achieved.
x (Poor): A coating film thickness of 100 μm was not achieved.

### Shape Tetention

◯ (Good): The coating film did not protrude from the pattern due to dripping.
x (Poor): The coating film protruded from the pattern.
-: Not evaluable.

### Room Temperature Adhesive Force: Peel Test

The cured product produced as above was cut to a width of 75 mm and a length of 125 mm and transferred onto the inner treated surface of an easy adhesion polyester film (“COSMOSHINE A4100”, available from Toyobo Co., Ltd.) such that the unsealed surface contacted the inner treated surface. The workpiece was cut to five specimens each having a width of 25 mm and a length of 200 mm (surface to be bonded 125 mm). Subsequently, the PET sheet opposite to the transfer surface was removed from each specimen. An adherend was bonded to the exposed surface and pressure-bonded by moving a 2-kg roller back and forth once thereon. The pressure-bonded specimen was subjected to 180° peeling at a speed of 300 mm/min using a universal tester (available from A AND D Company, Ltd., “TENSILON RTI-1310”). The room temperature adhesive force was measured using specimens adjusted to 25° C. The room temperature adhesive force was measured for adherends of two materials, Cu and Al, and evaluated in accordance with the following criteria.

### Evaluation Criteria

◯◯ (Excellent): 5 N/inch or greater
◯ (Good): 3 N/inch or greater and less than 5 N/inch
Δ (Fair): 1.5 N/inch or greater and less than 3 N/inch
x (Poor): Less than 1.5 N/inch (not bondable)

### Heat Dissipation Test

A chip resistor (available from Panasonic, “ERJ8GEYJ102V”) was mounted on a FR4 substrate with an electrically conductive adhesive (available from Fujikura Kasei Co., Ltd., “FA-705BN”), and the adhesive was thermally cured at 150° C. for 30 minutes, whereby a heat dissipation measurement substrate was obtained. A voltage at rated power calculated by the following formula was then applied. After five minutes, the hot-spot temperature (X) was measured by thermography.

V (voltage)=√[P (rated power)×R (resistance)] Formula

The UV-curable heat-dissipating resin compositions were each screen-printed on an aluminum plate and cured into a cured product by irradiation with UV light with an irradiation energy of 900 mJ/cm² using an LED curing device (available from Gro-up, “GUC-584M”) set to a UV irradiance of 300 W/cm² at a wavelength of 365 nm. The cured product was bonded to the back surface of the FR4 substrate. A voltage at rated power was applied to the chip resistor under the same conditions. After five minutes, the hot-spot temperature (Y) was measured by thermography. From the hot spot temperature (X) and the hot-spot temperature (Y), the hot-spot temperature decrease rate was determined by the following formula.

Hot-spot temperature decrease rate (%)=Y/X*100

### Evaluation Criteria

◯ (Good): Hot-spot temperature decrease rate of less than 100%
x (Poor): Hot-spot temperature decrease rate of 100% or higher

TABLE 1

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| (A) Nitrogen- | Lactam | NVC | 4.2 | 7.14 | 2.94 | 4.2 | 0.84 | 4.2 | 4.2 | 4.2 | 4.2 | — |
| containing | Non-lactam | ACMO | — | — | — | — | — | — | — | — | — | 4.2 |
| monomer | | DMAA | — | — | — | — | — | — | — | — | — | — |
| | | NVA | — | — | — | — | — | — | — | — | — | — |
| (B) Monofunctional | | IDAA | 12.2 | 20.74 | 8.54 | 12.2 | 2.44 | 12.2 | 12.2 | 12.2 | 12.2 | 12.2 |
| (meth)acrylate monomer | | 4HBA | 1.5 | 2.55 | 1.05 | 1.5 | 0.3 | 1.5 | 1.5 | 1.5 | 1.5 | 1.5 |
| (C) Crosslinking | Bifunctional | CN9004 | 0.25 | 0.425 | 0.175 | 0.25 | 0.05 | 0.25 | 0.25 | 0.25 | 0.25 | 0.25 |
| component | urethane | EB3700 | — | — | — | — | — | — | — | — | — | — |
| (D) Photopolymerization | | TPO | 0.15 | 0.255 | 0.105 | 0.15 | 0.15 | 0.15 | 0.15 | 0.15 | 0.15 | 0.15 |
| initiator | | 819 | — | — | — | — | — | — | — | — | — | — |
| | | 184 | — | — | — | — | — | — | — | — | — | — |
| (E) Thermally | Alumina | AL-35-75 | 50 | 35 | 56 | — | — | — | | 50 | 50 | 50 |
| conductive | Alumina | AA-3 | 21 | 15 | 24 | — | — | — | 21 | 21 | 21 | 21 |
| filler | Aluminum | H-21 | — | — | — | 40 | — | — | — | — | — | — |
| | hydroxide | | | | | | | | | | | |
| | Aluminum | H-42 | — | — | — | 16.8 | — | — | — | — | — | — |
| | hydroxide | | | | | | | | | | | |
| | Aluminum | SWE-20 | — | — | — | — | 52.7 | — | 50 | — | — | — |
| | nitride | | | | | | | | | | | |
| | Aluminum | SWE-2 | — | — | — | — | 22.1 | — | — | — | — | — |
| | nitride | | | | | | | | | | | |
| | Zinc oxide | LPZINC-30S | — | — | — | — | — | 95 | — | — | — | — |
| | Zinc oxide | LPZINC-2 | — | — | — | — | — | 39.9 | — | — | — | — |

| Defoamer | KS-66 | 1.2 | 2.04 | 0.84 | 1.2 | 1.2 | 1.2 | 1.2 | 1.2 | 1.2 | 1.2 |
|---|---|---|---|---|---|---|---|---|---|---|---|
| Thermoplastic resin | Acrylic polymer | 5 | 8.5 | 3.5 | 5 | 1 | 5 | 5 | 5 | 5 | 5 |
| with no reactivity | | | | | | | | | | | |
| Dispersant | BYK-111 | 0.05 | 0.035 | 0.05 | 0.05 | 0.05 | 0.05 | 0.05 | 0.05 | 0.05 | 0.05 |
| Tackifier | PE-590 | 4.5 | 7.65 | 3.15 | 4.5 | 0.9 | 4.5 | 4.5 | 2 | — | 4.5 |
| | KE-311 | — | — | — | — | — | — | — | — | 4.5 | — |
| Amount of nitrogen-containing monomer | | 14.46 | 14.38 | 14.45 | 14.46 | 12.12 | 14.46 | 14.46 | 15.82 | 14.46 | 14.46 |
| (excluding filler, % by weight) | | | | | | | | | | | |
| Amount of thermally conductive | | 43.4 | 23.4 | 54.0 | 23.7 | 23.4 | 24.1 | 43.4 | 44.4 | 45.4 | 43.4 |
| filler (% by volume) | | | | | | | | | | | |
| Thermal conductivity (W/m · K) | | 0.5 | 0.4 | 0.6 | 0.3 | 0.7 | 0.65 | 0.67 | 0.5 | 0.5 | 0.5 |
| Adhesive force 25° C. | Cu | ∘ | ∘ | Δ | ∘ | ∘ | ∘ | ∘ | Δ | ∘ | ∘ |
| | Al | ∘ | ∘ | Δ | ∘ | ∘ | ∘ | ∘ | Δ | ∘ | ∘ |

| | | | | | | | | | | |
|---|---|---|---|---|---|---|---|---|---|---|
| Heat dissipation test | ∘ | ∘ | ∘ | ∘ | ∘ | ∘ | ∘ | ∘ | ∘ | ∘ |

| | | | Example | | | | | | | | | |
|---|---|---|---|---|---|---|---|---|---|---|---|---|
| | | | 11 | 12 | 13 | 14 | 15 | 16 | 17 | 18 | 19 | 20 |
| (A) Nitrogen- | Lactam | NVC | — | — | 4.2 | 4.2 | 4.2 | 4.2 | 4.2 | 4.2 | 5.35 | 4.09 |
| containing | Non-lactam | ACMO | — | — | — | — | — | — | — | — | — | — |
| monomer | | DMAA | 4.2 | — | — | — | — | — | — | — | — | — |
| | | NVA | — | 4.2 | — | — | — | — | — | — | — | — |
| (B) Monofunctional | | IDAA | 12.2 | 12.2 | 12.2 | 12.2 | 12.2 | 12.2 | 13.7 | 12.2 | 15.53 | 11.87 |
| (meth)acrylate monomer | | 4HBA | 1.5 | 1.5 | 1.5 | 1.5 | 1.5 | 1.5 | — | 1.5 | 1.91 | 1.46 |
| (C) Crosslinking | Bifunctional | CN9004 | 0.25 | 0.25 | 0.25 | 0.25 | 0.25 | 0.25 | 0.25 | — | 0.32 | 0.24 |
| component | urethane | EB3700 | — | — | — | — | — | — | — | 0.25 | — | |
| (D) Photopolymerization | | TPO | 0.15 | 0.15 | — | — | 0.05 | 0.15 | 0.15 | 0.15 | 0.19 | 0.15 |
| initiator | | 819 | — | — | 0.15 | — | 0.05 | — | — | — | — | — |
| | | 184 | — | — | — | 0.15 | 0.05 | — | — | — | — | — |
| (E) Thermally | Alumina | AL-35-75 | 50 | 50 | 50 | 50 | 50 | 50 | 50 | 50 | 50 | 56 |
| conductive | Alumina | AA-3 | 21 | 21 | 21 | 21 | 21 | 21 | 21 | 21 | 21 | 24 |
| filler | Aluminum | H-21 | — | — | — | — | — | — | — | — | — | — |
| | hydroxide | | | | | | | | | | | |
| | Aluminum | H-42 | — | — | — | — | — | — | — | — | — | — |
| | hydroxide | | | | | | | | | | | |
| | Aluminum | SWE-20 | — | — | — | — | — | — | — | — | — | — |
| | nitride | | | | | | | | | | | |
| | Aluminum | SWE-2 | — | — | — | — | — | — | — | — | — | — |
| | nitride | | | | | | | | | | | |
| | Zinc oxide | LPZINC-30S | — | — | — | — | — | — | — | — | — | — |
| | Zinc oxide | LPZINC-2 | — | — | — | — | — | — | — | — | — | — |

| Defoamer | KS-66 | 1.2 | 1.2 | 1.2 | 1.2 | 1.2 | — | 1.2 | 1.2 | 1.2 | 0.84 |
|---|---|---|---|---|---|---|---|---|---|---|---|
| Thermoplastic resin | Acrylic polymer | 5 | 5 | 5 | 5 | 5 | 5 | 5 | 5 | — | — |
| with no reactivity | | | | | | | | | | | |
| Dispersant | BYK-111 | 0.05 | 0.05 | 0.05 | 0.05 | 0.05 | 0.05 | 0.05 | 0.05 | 0.05 | 0.05 |
| Tackifier | PE-590 | 4.5 | 4.5 | 4.5 | 4.5 | 4.5 | 4.5 | 4.5 | 4.5 | 4.5 | 3.15 |
| | KE-311 | — | — | — | — | — | — | — | — | — | — |
| Amount of nitrogen-containing monomer | | 14.46 | 14.46 | 14.46 | 14.46 | 14.46 | 15.08 | 14.46 | 14.46 | 17.52 | 17.44 |
| (excluding filler, % by weight) | | | | | | | | | | | |
| Amount of thermally conductive | | 43.4 | 43.4 | 43.4 | 43.4 | 43.4 | 46.4 | 43.4 | 43.4 | 43.4 | 54.0 |
| filler (% by volume) | | | | | | | | | | | |
| Thermal conductivity (W/m · K) | | 0.5 | 0.5 | 0.5 | 0.5 | 0.5 | 0.5 | 0.5 | 0.5 | 0.5 | 0.6 |
| Adhesive force 25° C. | Cu | ∘ | ∘ | ∘ | ∘ | ∘ | ∘ | ∘ | ∘ | ∘ | Δ |

| | | | | | | | | | | |
|---|---|---|---|---|---|---|---|---|---|---|
| Al | ∘ | ∘ | ∘ | ∘ | ∘ | ∘ | ∘ | ∘ | ∘ | Δ |

| | | | | | | | | | | |
|---|---|---|---|---|---|---|---|---|---|---|
| Heat dissipation test | ∘ | ∘ | ∘ | ∘ | ∘ | Δ | ∘ | ∘ | ∘ | ∘ |

| | | | Comparative Example | | | | | | | |
|---|---|---|---|---|---|---|---|---|---|---|
| | | | 1 | 2 | 3 | 4 | 5 | 6 | 7 | 8 |
| (A) Nitrogen- | Lactam | NVC | — | — | 4.2 | 17.9 | 4.2 | 4.2 | 9.66 | 1.07 |
| containing | Non-lactam | ACMO | — | — | — | — | — | — | — | — |
| monomer | | DMAA | — | — | — | — | — | — | — | — |
| | | NVA | — | — | — | — | — | — | — | — |
| (B) Monofunctional | | IDAA | 12.2 | 12.2 | 12.2 | — | 12.2 | 12.2 | 28.06 | 3.11 |
| (meth)acrylate monomer | | 4HBA | 2.6 | 2.6 | 1.5 | — | 1.5 | 1.5 | 3.45 | 0.38 |
| (C) Crosslinking | Bifunctional | CN9004 | 0.25 | 0.25 | 0.25 | 0.25 | 0.25 | — | 0.575 | 0.064 |
| component | urethane | | | | | | | | | |
| (D) Photopolymerization | | TPO | 0.15 | 0.15 | 0.15 | 0.15 | — | 0.15 | 0.345 | 0.038 |
| initiator | | 819 | — | — | — | — | — | — | — | — |
| | | 184 | — | — | — | — | — | — | — | — |
| (E) Thermally | Alumina | AL-35-75 | 50 | — | — | 50 | 50 | 50 | 28 | 63 |
| conductive | Alumina | AA-3 | 21 | — | — | 21 | 21 | 21 | 12 | 27 |
| filler | Aluminum | H-21 | — | — | — | — | — | — | — | — |
| | hydroxide | | | | | | | | | |
| | Aluminum | H-42 | — | — | — | — | — | — | — | — |
| | hydroxide | | | | | | | | | |
| | Aluminum | SWE-20 | — | — | — | — | — | — | — | — |
| | nitride | | | | | | | | | |
| | Aluminum | SWE-2 | — | — | — | — | — | — | — | — |
| | nitride | | | | | | | | | |
| | Zinc oxide | LPZINC-30S | — | — | — | — | — | — | — | — |
| | Zinc oxide | LPZINC-2 | — | — | — | — | — | — | — | — |

| Defoamer | KS-66 | 1.2 | 1.2 | 1.2 | 1.2 | 1.2 | 1.2 | 2.76 | 0.306 |
|---|---|---|---|---|---|---|---|---|---|
| Thermoplastic resin | Acrylic polymer | 5 | 5 | 5 | 5 | 5 | 5 | 11.5 | 1.28 |
| with no reactivity | | | | | | | | | |
| Dispersant | BYK-111 | 0.05 | 0.05 | 0.05 | 0.05 | 0.05 | 0.05 | 0.05 | 0.05 |
| Tackifier | PE-590 | 7.65 | 7.65 | 4.5 | 4.5 | 4.5 | 4.5 | 4.5 | 4.5 |
| | KE-311 | — | — | — | — | — | — | — | — |
| Amount of nitrogen-containing monomer | | 0.00 | 0.00 | 14.46 | 61.62 | 14.53 | 14.58 | 15.86 | 9.92 |
| (excluding filler, % by weight) | | | | | | | | | |
| Amount of thermally conductive | | 45.4 | 45.4 | 43.4 | 47.4 | 48.4 | 49.4 | 50.4 | 73.3 |
| filler (% by volume) | | | | | | | | | |
| Thermal conductivity (W/m · K) | | 0.5 | 0.1 | 0.1 | 0.5 | 0.5 | 0.5 | 0.1 | Sample not |
| | | | | | | | | | producible |
| Adhesive force 25° C. | Cu | x | Δ | ∘ | x | x | Δ | ∘ | x |
| | Al | x | Δ | ∘ | x | x | Δ | ∘ | x |

| | | | | | | | | |
|---|---|---|---|---|---|---|---|---|
| Heat dissipation test | Not | x | x | Not | Not | Δ | x | Not |
| | measurable | | | measurable | measurable | | | measureable |

TABLE 3

| | | Thermal | True | |
|---|---|---|---|---|
| | Average | conduc- | spe- | |
| | particle | tivity | cific | |
| Filler | size | [W/m · | gravi- | |
| composition | [μm] | K] | ty | Manufacturer |
| Alumina | 35 | 30 | 3.9 | Nippon Steel |
| | | | | Chemical & Material |
| | | | | Co., Ltd. |
| Alumina | 3 | 30 | 3.9 | Sumitomo Chemical |
| | | | | Co., Ltd. |
| Aluminum hydroxide | 27 | 3.5 | 2.4 | Showa Denko K.K. |
| Aluminum hydroxide | 1 | 3.5 | 2.4 | Showa Denko K.K. |
| Aluminum nitride | 20 | 200 | 3.2 | Thrutek Applied |
| | | | | Materials Co., Ltd. |
| Aluminum nitride | 2 | 200 | 3.2 | Thrutek Applied |
| | | | | Materials Co., Ltd. |
| Zinc oxide | 30 | 45 | 5.6 | Sakai Chemical |
| | | | | Industry Co., Ltd. |
| Zinc oxide | 2 | 45 | 5.6 | Sakai Chemical |
| | | | | Industry Co., Ltd. |

TABLE 4

| Example 1 | | Example 2 | Example 3 | Example 4 | Example 5 | Example 6 | Example 7 | Example 8 | Example 9 |
|---|---|---|---|---|---|---|---|---|---|
| Screen | Dispensing | Screen | Screen | Screen | Screen | Screen | Screen | Screen | Screen |
| printing | coating | printing | printing | printing | printing | printing | printing | printing | printing |
| ∘ | ∘ | ∘ | ∘ | ∘ | ∘ | ∘ | ∘ | ∘ | ∘ |
| ∘ | ∘ | ∘ | ∘ | ∘ | ∘ | ∘ | ∘ | ∘ | ∘ |
| ∘ | ∘ | ∘ | ∘ | ∘ | ∘ | ∘ | ∘ | ∘ | ∘ |

| Example 10 | Example 11 | Example 12 | Example 13 | Example 14 | Example 15 | Example 16 | Example 17 | Example 18 | Example 19 |
|---|---|---|---|---|---|---|---|---|---|
| Screen | Screen | Screen | Screen | Screen | Screen | Screen | Screen | Screen | Screen |
| printing | printing | printing | printing | printing | printing | printing | printing | printing | printing |
| ∘ | ∘ | ∘ | ∘ | ∘ | ∘ | ∘ | ∘ | ∘ | ∘ |
| ∘ | ∘ | ∘ | ∘ | ∘ | ∘ | ∘ | ∘ | ∘ | ∘ |
| ∘ | ∘ | ∘ | ∘ | ∘ | ∘ | ∘ | ∘ | ∘ | ∘ |

| | | Comparative | Comparative | Comparative | Comparative | Comparative | Comparative | Comparative |
|---|---|---|---|---|---|---|---|---|
| Example 20 | | Example 1 | Example 2 | Example 3 | Example 5 | Example 6 | Example 7 | Example 8 |
| Screen | Dispensing | Screen | Screen | Screen | Screen | Screen | Screen | Screen |
| printing | coating | printing | printing | printing | printing | printing | printing | printing |
| ∘ | ∘ | ∘ | ∘ | ∘ | ∘ | ∘ | ∘ | x |
| ∘ | ∘ | ∘ | ∘ | ∘ | ∘ | x | ∘ | x |
| ∘ | ∘ | ∘ | ∘ | ∘ | ∘ | ∘ | ∘ | — |

### INDUSTRIAL APPLICABILITY

The present invention can provide a UV-curable heat-dissipating resin composition having excellent printability, excellent heat dissipation properties, and excellent adhesion to various substrates. The present invention can also provide a heat-dissipating adhesive sheet containing the UV-curable heat-dissipating resin composition, a laminate, and a method for producing a laminate.

1. A UV-curable heat-dissipating resin composition comprising:
(A) a nitrogen-containing monomer;
(B) a monofunctional (meth)acrylate monomer;
(C) a crosslinking component;
(D) a photopolymerization initiator; and
(E) a thermally conductive filler having a thermal conductivity of 3 W/m·K or higher,
the thermally conductive filler (E) being contained in an amount of 20 to 70% by volume,
the nitrogen-containing monomer (A) being contained in an amount of 10 to 35% by weight relative to a whole amount of the composition excluding the thermally conductive filler (E).

2. The UV-curable heat-dissipating resin composition according to claim 1, further comprising a nonreactive component having no reactivity with the nitrogen-containing monomer (A) nor with the monofunctional (meth)acrylate monomer (B).

3. The UV-curable heat-dissipating resin composition according to claim 2,
wherein the nonreactive component is contained in a ratio of 0.1 to 140 parts by weight to 100 parts by weight of a total amount of the nitrogen-containing monomer (A) and the monofunctional (meth)acrylate monomer (B).

4. The UV-curable heat-dissipating resin composition according to claim 2,
wherein the nonreactive component contains at least one of a thermoplastic resin or a tackifier.

5. The UV-curable heat-dissipating resin composition according to claim 1,
wherein the nitrogen-containing monomer (A) includes a monomer having a negative e value.

6. The UV-curable heat-dissipating resin composition according to claim 2,
wherein the crosslinking component (C) has reactivity with the nitrogen-containing monomer (A) and the monofunctional (meth)acrylate monomer (B) or has reactivity with the nitrogen-containing monomer (A), the monofunctional (meth)acrylate monomer (B), and the nonreactive component.

7. The UV-curable heat-dissipating resin composition according to claim 1,
wherein the crosslinking component (C) has at least one binding functional group selected from the group consisting of an isocyanate group, an epoxy group, an aldehyde group, a hydroxy group, an amino group, a (meth)acrylate group, and a vinyl group.

8. The UV-curable heat-dissipating resin composition according to claim 1,
wherein the crosslinking component (C) contains a (meth)acrylate monomer that in a form of a homopolymer has a gel fraction of 80% or higher.

9. The UV-curable heat-dissipating resin composition according to claim 1,
wherein the crosslinking component (C) is a (meth)acrylate monomer having a viscosity at 25° C. of 10,000 cps or higher and is contained in an amount of 0.1 to 25% by weight in 100% by weight of a total amount of the nitrogen-containing monomer (A), the monofunctional (meth)acrylate monomer (B), and the crosslinking component (C).

10. The UV-curable heat-dissipating resin composition according to claim 1,
wherein the thermally conductive filler (E) is an inorganic filler containing at least one compound selected from the group consisting of a metal oxide, a metal hydroxide, a metal nitride, a metal carbide, and a metal boride.

11. The UV-curable heat-dissipating resin composition according to claim 1, which has a thermal conductivity of 0.30 W/m·K or higher after being cured.

12. The UV-curable heat-dissipating resin composition according to claim 1, further comprising a dispersant in an amount of 0.01 to 5.0% by weight relative to 100% by weight of the thermally conductive filler (E).

13. The UV-curable heat-dissipating resin composition according to claim 1,
wherein the photopolymerization initiator (D) is contained in an amount of 0.2 to 10 parts by weight relative to 100 parts by weight of a total amount of the nitrogen-containing monomer (A) and the monofunctional (meth)acrylate monomer (B).

14. A heat-dissipating adhesive sheet comprising:
a substrate; and
a heat-dissipating adhesive layer on at least one surface of the substrate, the heat-dissipating adhesive layer containing the UV-curable heat-dissipating resin composition according to claim 1.

15. The heat-dissipating adhesive sheet according to claim 14,
wherein the heat-dissipating adhesive layer is disposed on part of the substrate.

16. A laminate comprising a first adherend and a second adherend bonded to each other with the heat-dissipating adhesive layer of the heat-dissipating adhesive sheet according to claim 14.

17. A method for producing a laminate, comprising:
applying the UV-curable heat-dissipating resin composition according to claim 1 to a first adherend;
exposing the UV-curable heat-dissipating resin composition to light to form a heat-dissipating adhesive layer; and
bonding a second adherend to the heat-dissipating adhesive layer to form a laminate.

18. The method for producing a laminate according to claim 17,
wherein the UV-curable heat-dissipating resin composition is applied by ink-jet printing, screen printing, spray coating, or spin coating, and the UV-curable heat-dissipating resin composition is applied to part of the first adherend.
